(19) United States
(12) Patent Application Publication
(10) Pub. No.: US 2013/0227920 A1
(43) Pub. Date: Sep. 5, 2013

(54) Saddle pad eliminating the area of highest pressure from saddle tree bars with circle cut out areas lined with silicon rubber.

(71) Applicant: Mariti Antonio Munoz, Brownsville, TX (US)

(72) Inventor: Mariti Antonio Munoz, Brownsville, TX (US)

(21) Appl. No.: 13/412,578

(22) Filed: Mar. 5, 2012

(51) Int. Cl. B68C 1/12

(52) U.S. Cl. 54/66

(57) ABSTRACT

An improved saddle pad placed between the saddle and a horse that suspends the areas of highest pressure points from saddle bars. The improved saddle pad redistributes surrounding pressure evenly 360 degrees, not allowing highest pressure point areas from saddle bars to touch the shoulders of the horse. In a preferred embodiment, a circle cutout is reinforced with silicone rubber to prevent wear and redistributes surrounding pressure and allows the saddle bars to settle within circle cut out area pad closer to the horse reducing roll from side to side.

### BACKGROUND OF THE INVENTION

1. Field of the Invention

Applicant's invention relates to saddle pads and other such padding devices used to reduce a riding horse's discomfort as caused by saddles. More particularly, it relates to a saddle pad designed to eliminate pressure applied by the saddle to the horse's back across the saddle were the saddle bars create highest amounts of pressure.

2. Background Information

Saddle pads are ancient devices that continue to be used in modern times. It was found that saddles; of all types, if used directly on a horse's back, tended to cause galling, or sores, to develop on the horse's back as the result of pressure and rubbing exerted by the saddle on the horse's back. This was the result of virtually any rigid type saddle. But, because the characteristics of a rigid saddle were, and are, desirable, rigid saddles remain the norm.

To combat galling, riders place protective padding over the horse's back between the animal and the saddle. Saddle pads, or as they are sometimes referred to as saddle blankets, began as course woven blankets, generally made from cotton or wool. Saddle pads of this type were the standard until relatively recently. With the advent of many new manmade and composite materials to choose from, saddle pads are now being made in a wide variety of such materials. The new materials have allowed saddle pad manufacturers to improve the shock absorbency and comfort of the newer saddle pads.

However, despite these improvements, problems still remain. Western saddles are still made in a manner that creates pressure points. This is because the “skeleton” of the saddle is a hard tree made from wood, plastic or fiberglass. The tree is then covered by the various layers of leather and an inner covering of either natural or manmade fleece. However, because the weight of the rider presses down on the top of the saddle, the pressure is transferred through the hard tree and directed toward the horse's back. Although the leather covering, or skirts, are relatively thick and stiff, they are still flexible which allows them to “lift” or flex as the rider's weight presses down. Thus, although the saddle skirt may cover a wide area it does little to reduce the pressure exerted by the tree, the majority of pressure is exerted over a relatively small area beneath the tree.

In order to combat this problem and in an attempt to combat the pressure exerted by the tree, the standard practice has been to increase the thickness of the padding. This can be done either by using multiple saddle pads or increasing the thickness of a single saddle pad. Additionally, because the problem of the pressure points exerted by the tree has been recognized, inventions disclosed in the prior art follow the same line of reasoning by increasing the thickness of the saddle pad in the area beneath the tree, adding inserts beneath the tree, or increasing the shock absorption or density of the saddle pad beneath the tree, and still we have the roaning of hair due to pressure from saddle bars and if not addressed can turn into open sores. Adding more padding further separates saddle and rider from horse's back creating more potential for saddle to roll side to side when in use.

This line of reasoning can be seen in patents such as: Zilka, U.S. Pat. No. 6,370,850, which uses a material with greater resistance to compression and an increased ability to absorb concussive and compressive forces in the remainder of the pad; Woods, U.S. Pat. No. 5,802,823, which adds multiple shock absorbing panels to the saddle pad; Knight, et al, U.S. Pat. No. 5,782,070, which incorporates an inflatable bladder to increase the padding; Garrison, U.S. Pat. No. 5,363,631, which incorporates plastic-encased gel molds; Cudney, et al, U.S. Pat. No. 5,299,412, which adds an impact absorbing foam core to the saddle pad; Evertson, U.S. Pat. No. 5,058,367, which provides increased padding beneath the saddle; Gleb, et al, U.S. Pat. No. 5,027,589, which incorporates two envelopes on either side of the saddle pad designed to receive foam inserts; Ricken, U.S. Pat. No. 4,974,397, which incorporates multiple layers to attempt to disburse the pressure; Gonzales, U.S. Pat. No. 4,827,701, which discloses thickened pads located at pressure points; and Vasko, et al, U.S. Pat. No. 4,683,709, which incorporates a pair of pockets which can receive shock absorbing inserts.

As exemplified above, the general approach to combating the pressure points has been to increase the thickness of the saddle pad beneath the pressure points. It would therefore be advantageous to provide an alternative, effective method for reducing pressure points exerted by the saddle and rider without increasing the thickness or density of the saddle pad beneath the pressure points.

Typically as horses get older this area of concern loses muscle due to atrophy, and is more prone to develop sores. Once open soars appear it is hard to heal wounds with continual usage and many horsemen and women depend on these horses for their livelihood. Thus, there is a need for a device for eliminating main pressure points area under the saddle.

### BRIEF DESCRIPTION OF THE DRAWINGS

FIG. 1 is a perspective view of the improved saddle pad with a cross section view, a portion of the symmetric second side.

FIG. 2 is a bottom view of the improved saddle pad.

FIG. 3 is an above view of a horse with improved pad in place.

FIG. 4 is a perspective view of a saddle tree.

FIG. 5 is the left side of the horse illustrating the present invention in use.

FIG. 6 is an exploded view of the circle cut out area with silicon ring.

### DETAILED DESCRIPTION OF THE PREFERRED EMBODIMENT

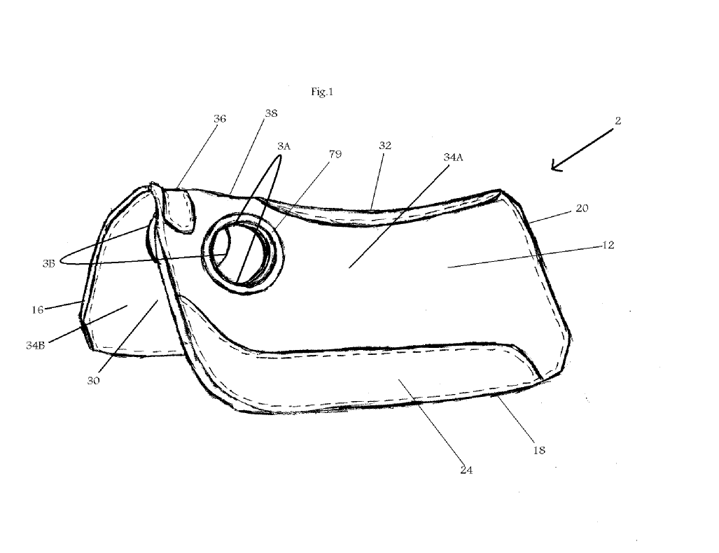

Referring to the figures, FIG. 1 is a side view in perspective of the present invention. It is illustrative of a modern style saddle pad (2). This figure illustrates a general shape of a saddle pad (2) that incorporates a circle cutout area (3A and 3B). The pad standard area (12) is of uniform thickness with a circle cutout area (3A). The circle cutout area (3A) is designed to fit beneath the portion of the tree bar (50A) within which the saddle tree (4) settles. It should be understood that FIG. 1 illustrates a pad first side, (34A) and a portion of the symmetrical second side (34B). The saddle pad (2) is designed to lay over an animal's, such as a horse (8), back with the pad (2) middle seam (32) laying along the animal's spine. The saddle pad (2) is sized to fit over a portion of the animal's (8) back symmetrically.

FIG. 1 also illustrates that many features incorporated in modern saddle pads (2) can also be incorporated in a saddle pad (2) of the present invention. For example, an expansion slot (38) is designed to lay over a horse's withers and allow for better fit, and a contour shaped middle seam (32) allows the saddle pad (2) to fit the natural shape of a horses back, (not shown) additionally protective materials such as the wear leather (24) and the gullet wear leather (36) can help resist wear and enhance the saddle pad (2) aesthetically.

In order to fit a maximum number of saddle tree (4), some embodiments of the present invention may be of a fairly generic shape such as is shown in FIG. 1. However, it is anticipated that saddle pads (2) could be designed for specific saddle tree (4) with circle cutout areas (3A and 3B) sized to fit a specific saddle tree (4).

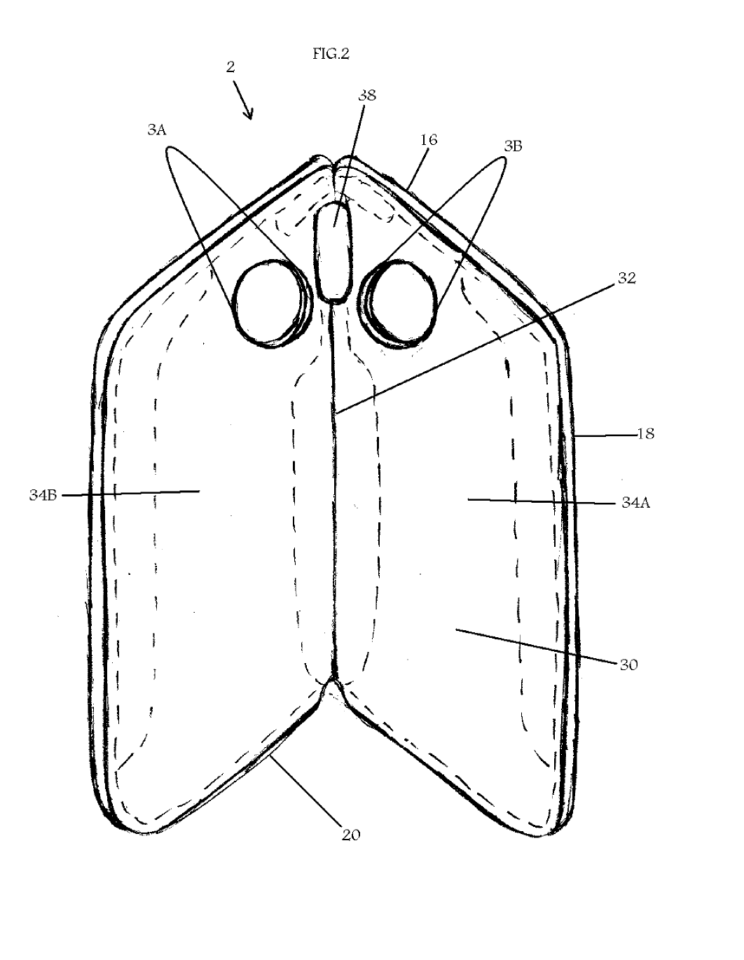

FIG. 2 is an underside view of the present invention. The pad bottom surface (30) lays against the back and sides of the horse with the pad middle seam (32) laying along the spine of the animal and the pad bottom edge (18) extending down the side of the animal. This figure more clearly shows the circle cut outs (3A and 3B) on the shoulder. The pad sides (34A and 34B) are made from wool, felt or a blend of materials. In the embodiment illustrated in FIG. 2, the underside material is constant from beginning to end.

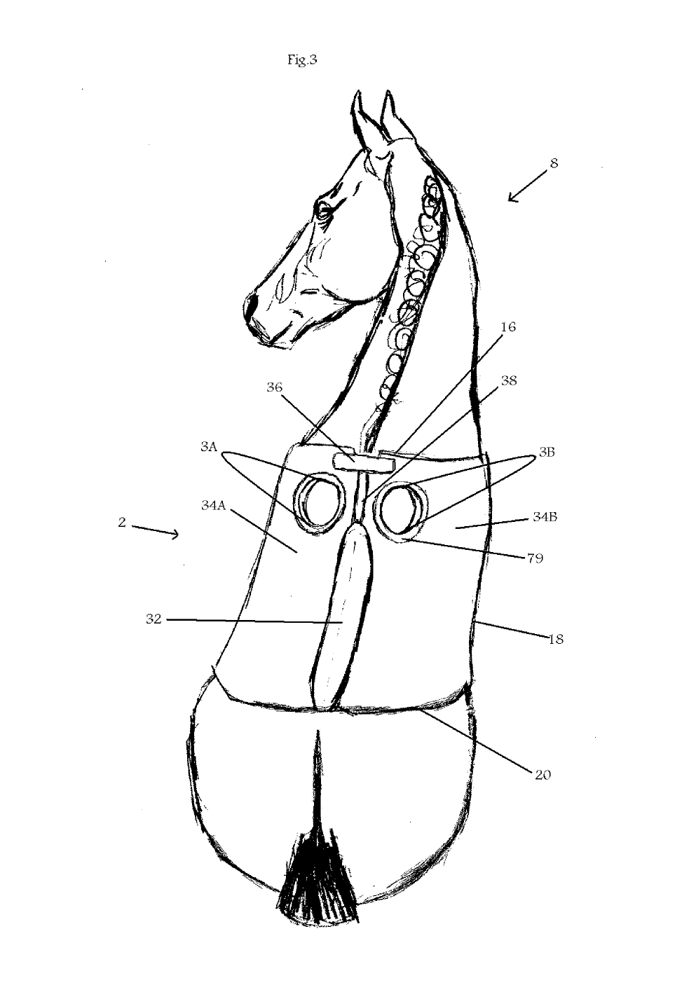

FIG. 3 is an above view of the present invention in place on a horse (8). This figure more clearly shows the circle cut outs (3A and 3B) on the shoulder of horse (8) that correspond to the areas beneath the saddle tree (4) which apply the most pressure.

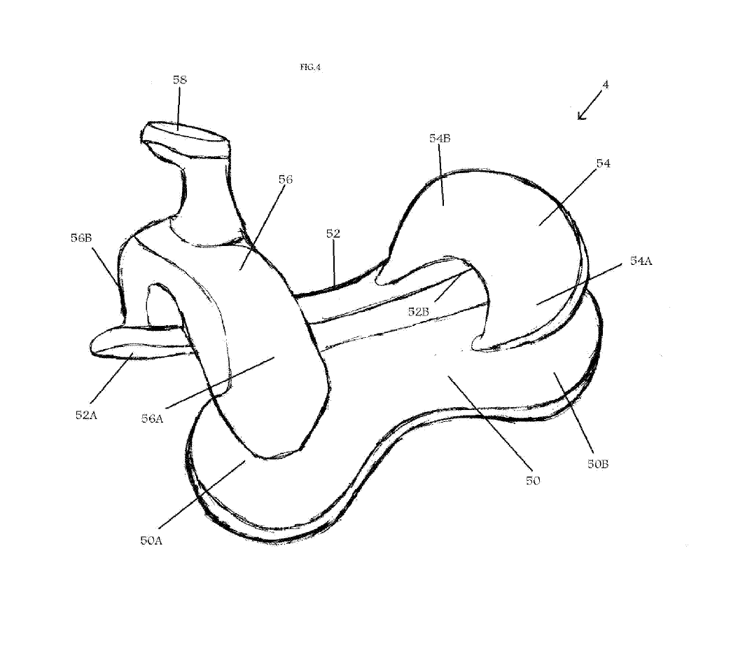

FIG. 4 illustrates a saddle tree (4). This figure is included in order to show the saddle tree (4) that creates the pressure points which the present invention eliminates. The saddle tree (4) is traditionally made from rawhide covered wood; however, like many other items, many other materials such as fiberglass, nylon, and plastics are now being used to make saddle trees (4). The general structure of the tree includes an arched pommel (56) and arched cantle (54). At the top of the arch of the pommel (56) is a tree horn (58). The pommel first end (56A) is attached to a first bar first end (50A). The first bar (50) extends backward from the pommel first end (56A) where it attaches to the cantle first end (54A). Likewise, a second bar (52) is attached at its first end (52A) to the pommel second end (56B), and the second bar second end (52B) is attached to the cantle second end (54B). It is the first bar ends (50A and 52B) under which the highest pressure points develop. The rigidity of the saddle tree (4) helps maintain the shape , as well as providing support and a solid base for the rider as well as other items that may be tied or attached to the saddle tree (4).

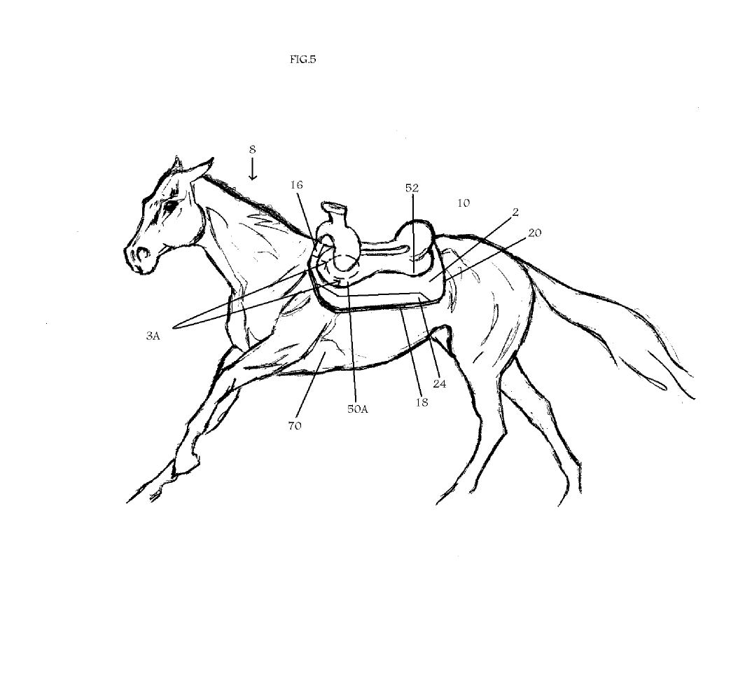

FIG. 5 illustrates the saddle pad (2) in place on a horse (8) with a saddle tree (4). The pad front edge (16) generally extends slightly in front of the saddle tree (4) while the pad rear edge (20) generally extends behind the saddle tree (4). The girth (70) extends from either side of the saddle tree (4) around the horse (8) and holds the saddle tree (4) and saddle pad (2) tightly in place. The wear leather (24) helps protect the saddle pad (2) from wear at the point where the girth (70) connects with the saddletree (4) which often causes excessive wear to the saddle pad (2). Indicated in FIG. 5 is the location of the second tree bar (50A) suspended on the saddle pad (2), and more specifically over the circle cutout area (3A) because the remainder of the skirt inner surface rests on the silicon ring (79) and the pad standard area (12) of the saddle pad (2) thus disbursing the downward forces and eliminating highest pressure-point within the first bar inner surface (50A). The first bar (50A) and the second bar (52A) have inner surface, allowing them to settle within circle cut out areas (3A and 3B) closer to the animal thus reducing the potential of roll from side to side.

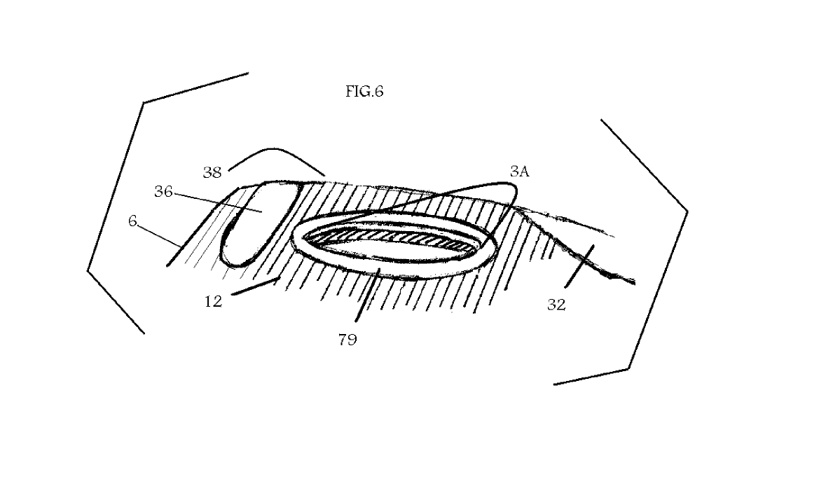

FIG. 6 illustrates the circle cut out area (3A) and the silicon ring (79) embedded in pad.

Although the invention has been described with reference to specific embodiments, this description is not meant to be construed in a limited sense. Various modifications of the disclosed embodiments, as well as alternative embodiments of the inventions will become apparent to-persons skilled in the art upon the reference to the description of the invention.

1. A saddle pad to cushion and suspend pressure created from bars of a saddle having voids formed within said pad that correspond to highest pressure points created from bars of saddle.

2. The saddle pad of claim 1, wherein said circle cut-out area is sized such that it is larger than that portion of said saddle tree bar that exerts highest pressure upon said animal.

3. The saddle pad of claim 1, wherein said circle cut-out area allows saddle and rider to sit closer to animal's back, thus reducing amount of roll of saddle side to side when in use.

4. The saddle pad of claim 1, wherein said circle cut out area is lined with a ring of silicon cured into wool, felt approximately ½ inch to ¾ thick and 1 inch wide with a shore A hardness 20 and tear strength 108 pli.
